(19) United States
(12) Patent Application Publication
(10) Pub. No.: US 2025/0173409 A1
(43) Pub. Date: May 29, 2025

(54) HUB DEVICE

(71) Applicant: Pu-Dan Limited Corp., New Taipei City (TW)

(72) Inventor: Wei-Chih HUANG, New Taipei City (TW)

(21) Appl. No.: 18/956,205

(22) Filed: Nov. 22, 2024

(30) Foreign Application Priority Data
Nov. 23, 2023 (TW) 112145346

(51) Int. Cl. G06F 21/31

(52) U.S. Cl. CPC G06F 21/31

(57) ABSTRACT

A hub device is provided. An upstream-facing port (UFP) receives an access command provided by an electronic device. A downstream-facing port (DFP) is coupled to a peripheral device. A control chip is coupled between the UFP and the DFP and includes a control logic circuit. The control logic circuit determines whether a user account and a user password provided by the electronic device are legal. In response to the user account and the user password being legal, the control logic circuit determines whether the user account has the authority to access the DFP. In response to the user account not having the authority to access the DFP, the control logic circuit ignores the access command. In response to the user account having the authority to access the DFP, the control logic circuit transmits the access command to the DFP.

### CROSS REFERENCE TO RELATED APPLICATIONS

This application claims priority of Taiwan Patent Application No. 112145346, filed on Nov. 23, 2023, the entirety of which is incorporated by reference herein.

### BACKGROUND OF THE INVENTION

### Field of the Invention

The present invention relates to a hub device, and, in particular, to a hub device with a data protection function.

### Description of the Related Art

Thanks to advancements in science and technology, there are more and more types of electronic devices, and they offer an increasingly wide array of functions. In daily life, Universal Serial Bus (USB) technology has become ubiquitous. For example, mobile phones, TVs, stereos, and printers all have USB interfaces. USB flash drives are electronic products that many people carry with them. However, most notebook computers have a limited number of connection ports, and users cannot use a single notebook computer's installed connection ports to connect all of their peripheral devices at once.

### BRIEF SUMMARY OF THE INVENTION

In accordance with an embodiment of the disclosure, a hub device comprises an upstream-facing port (UFP), a downstream-facing port (DFP), and a control chip. The upstream-facing port receives an access command provided by an electronic device. The downstream-facing port is coupled to a peripheral device. The control chip is coupled between the UFP and the DFP and comprises a first transceiver interface, a second transceiver interface, and a control logic circuit. The first transceiver interface is coupled to the UFP. The second transceiver interface is coupled to the DFP. The control logic circuit is coupled between the first and second transceiver interfaces. The control logic circuit directs the electronic device to provide a user account and a user password in response to the UFP receiving the access command. The control logic circuit determines whether the user account and the user password are legal. In response to the user account and the user password being legal, the control logic circuit determines whether the user account has the authority to access the DFP. In response to the user account not having the authority to access the DFP, the control logic circuit ignores the access command. In response to the user account having the authority to access the DFP, the control logic circuit transmits the access command to the DFP.

In accordance with another embodiment of the disclosure, a hub device comprises a UFP, a DFP, and a control chip. The UFP receives an access command provided by an electronic device. The DFP is coupled to a peripheral device. The control chip is coupled between the UFP and the DFP and comprises a first transceiver interface, a second transceiver interface, a first storage circuit, and a control logic circuit. The first transceiver interface is coupled to the UFP. The second transceiver interface is coupled to the DFP. The first storage circuit stores a first table which records a plurality of legal accounts and a plurality of legal passwords. Each legal account corresponds to one legal password. The control logic circuit is coupled between the first and second transceiver interfaces. The control logic circuit directs the electronic device to provide a user account and a user password in response to the UFP receiving the access command. The control logic circuit determines whether the user account matches one of the legal accounts in the first table. In response to the user account matching a specific legal account of the legal accounts, the control logic circuit determines whether the user password matches a legal password corresponding to the specific legal account in the first table. In response to the user password matching the legal password corresponding to the specific legal account and the access command pointing to the DFP, the control logic circuit determines whether the user account has the authority to access the DFP. In response to the user account not having the authority to access the DFP, the control logic circuit ignores the access command. In response to the user account having the authority to access the DFP, the control logic circuit transmits the access command to the DFP.

In accordance with another embodiment of the disclosure, a hub device comprises a UFP, a DFP, and a control chip. The UFP receives an access command provided by an electronic device. The DFP is coupled to a peripheral device. The control chip is coupled between the UFP and the DFP and comprises a first transceiver interface, a second transceiver interface, a first storage circuit, and a control logic circuit. The first transceiver interface is coupled to the UFP. The second transceiver interface is coupled to the DFP. The control logic circuit is coupled between the first and second transceiver interfaces. The control logic circuit directs the electronic device to provide a user account and a user password in response to the UFP receiving the access command. The control logic circuit determines whether the user account and the user password are legal. In response to the user account and the user password being legal and the access command pointing the first storage circuit, the control logic circuit determines whether the user account has the authority to access the first storage circuit. In response to the user account not having the authority to access the first storage circuit, the control logic circuit ignores the access command. In response to the user account having the authority to access the first storage circuit, the control logic circuit transmits the access command to the first storage circuit.

### BRIEF DESCRIPTION OF THE DRAWINGS

The present invention can be more fully understood by reading the subsequent detailed description and examples with references made to the accompanying drawings, wherein:

FIG. 1 is a schematic diagram of an exemplary embodiment of a control system according to various aspects of the present disclosure.

FIG. 2 is a schematic diagram of an exemplary embodiment of a control chip according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

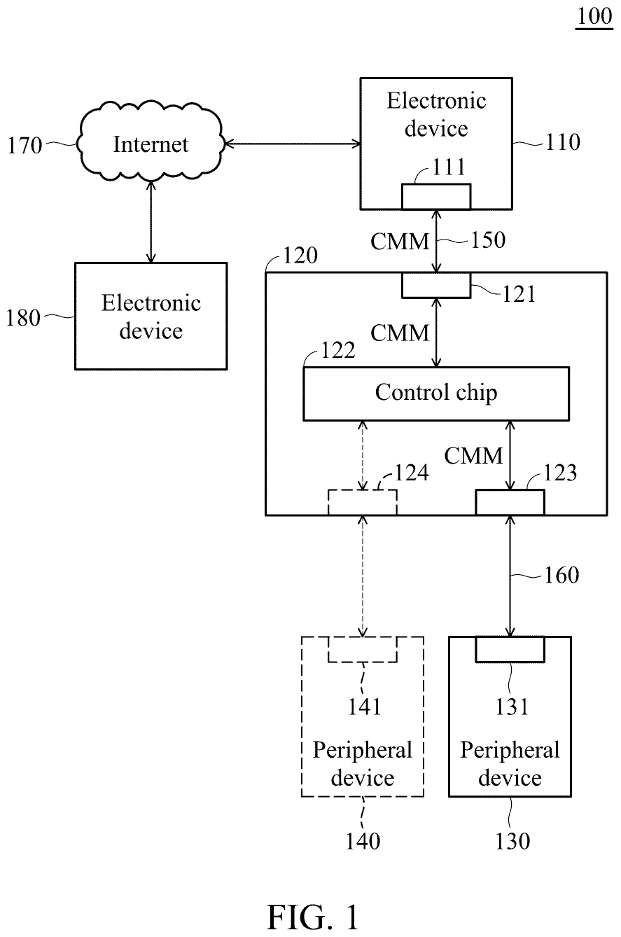

FIG. 1 is a schematic diagram of an exemplary embodiment of a control system according to various aspects of the present disclosure. As shown in FIG. 1, the control system 100 comprises an electronic device 110, a hub device 120, and a peripheral device 130. The electronic device 110 is coupled to the hub device 120. The kind of electronic device 110 is not limited in the present disclosure. In one embodiment, the electronic device 110 is a smart phone, a desktop computer, a notebook computer, or an access point (AP). In some embodiments, the electronic device 110 may be coupled to the internet 170. In this case, other devices (e.g., the electronic device 180) coupled to the internet 170 can connect to the hub device 120 via the electronic device 110 and the other devices further control the peripheral device 130 via the hub device 120.

The structure of electronic device 110 is not limited in the present disclosure. In one embodiment, the electronic device 110 comprises a connection port 111. The connection port 111 is coupled to the hub device 120 and output an access command CMM. The kind of connection port 111 is not limited in the present disclosure. In one embodiment, the connection port 111 is a USB Type-A connection port, a USB Type-C connection port, or a local area network (LAN) connection port.

The connection method between the connection port 111 and the hub device 120 is not limited in the present disclosure. In one embodiment, the connection port 111 may be connected to the hub device 120 via a connection cable 150. The type of the connection cable 150 is not limited in the present disclosure. The connection cable 150 may be a USB connection cable or a network cable. In another embodiment, the connection port 111 is directly plugged into the hub device 120. In other embodiments, the connection port 111 uses a wireless transmission technology to transmit data to the hub device 120. In this case, the connection port 111 has a wireless transceiver (not shown) for receiving signals from the hub device 120 or outputting signals to the hub device 120.

The peripheral device 130 is coupled to the hub device 120. In one embodiment, the peripheral device 130 comprises a connection port 131. The connection port 131 is coupled to the hub device 120. The kind of connection port 131 is not limited in the present disclosure. In one embodiment, the connection port 131 is a USB Type-A connection port or a USB Type-C connection port. In some embodiments, the connection port 131 may connect to the hub device 120 via a connection cable 160.

The number of peripheral devices is not limited in the present disclosure. In one embodiment, the control system 100 comprises more peripheral devices. For example, the control system 100 further comprises a peripheral device 140. The peripheral device 140 comprises a connection port 141. The connection port 141 is coupled to the hub device 120. Since the characteristic of the peripheral device 140 is similar to the characteristic of the peripheral device 130, the related description is omitted here. The types of peripheral devices 130 and 140 are not limited in the present disclosure. In one embodiment, the peripheral device 130 or 140 is a home appliance, such as a television or a stereo. In another embodiment, the peripheral device 130 or 140 is a computer peripheral accessory, such as a printer, a monitor, a flash drive, etc.

The hub device 120 is coupled between the electronic device 110, the peripheral devices 130 and 140 and comprises an upstream-facing port (UFP) 121, a control chip 122, and a downstream-facing port (DFP) 123. In one embodiment, the hub device 120 is a USB hub device. The USB hub device may comply with USB2.0, USB3.0, USB 3.1, USB 3.2 or USB4.0 standards.

The UFP 121 is coupled to the connection port 111 for receiving the access command CMM. The type of UFP 121 is not limited in the present disclosure. In one embodiment, the UFP 121 is a USB Type-A connection port, a USB Type-C connection port, or a LAN connection port. The UFP 121 may use a wired transmission method to receive the access command CMM. In another embodiment, the UFP 121 may use a wireless transmission method to receive the access command CMM. In this case, the UFP 121 may include a wireless transceiver (not shown) for receiving the access command CMM from the electronic device 110 and sending wireless signals to the electronic device 110.

The DFP 123 is used to couple to the connection port 131 of the peripheral device 130. In this embodiment, the type of the DFP 123 is the same as the type of the connection port 131. For example, the DFP 123 and the connection port 131 are USB Type-A connection ports or USB Type-C connection ports. The number of DFPs is not limited in the present disclosure. In other embodiments, the hub device 120 further comprises a DFP 124. The DFP 124 is used to couple to the connection port 141 of the peripheral device 140. Since the characteristic of the DFP 124 is similar to the characteristic of the DFP 123, the related description is omitted here.

The control chip 122 is coupled between the UFP 121 and the DFPs 123 and 124. When the control chip 122 receives the access command CMM, this indicates that the electronic device 110 wants to access the peripheral device 130 or 140. In order to protect the peripheral devices 130 and 140, the control chip 122 requires the electronic device 110 to provide a user account and a user password. The control chip 122 determines whether the user account and user password are legal.

When the user account and the user password are legal, the control chip 122 determines whether to allow the electronic device 110 to access the peripheral device 130 or 140 according to the access authority of the user account. Taking the peripheral device 130 as an example, when the access authority of the user account does not match the security level of the peripheral device 130, the control chip 122 rejects the access command CMM of the electronic device 110. At this time, the control chip 122 may prevent the access command CMM from entering the DFP 123. In another embodiment, the control chip 122 sends a warning message to notify the user. However, when the access authority of the user account matches the security level of the peripheral device 130, the control chip 122 sends the access command CMM to the DFP 123. The DFP 123 operates according to the access command CMM, such as providing specific data to the electronic device 110.

In other embodiments, the electronic device 110 is connected to the internet 170. The electronic device 110 may use a network cable (not shown) or a wireless method to connect to the internet 170. In one embodiment, the electronic device 110 is an access point. In some embodiments, the internet 170 is further connected to an electronic device 180. The electronic device 180 is connected to the hub device 120 via the internet 170 and the electronic device 110, and communicates with the peripheral device 130 or 140 via the hub device 120, such as instructing the peripheral device 130 to print a document.

In some embodiments, during an initial period, the security level of each of the DFPs 123 and 124 is a lowest level. When a specific application of the electronic device 110 is activated, the user can write multiple legal accounts, multiple legal passwords, and the access authorities to the hub device 120 via the specific application. Each of the access authorities corresponds to one legal account. The hub device 120 stores information provided by the electronic device 110. In one embodiment, the hub device 120 generates a first table according to the security information provided by the electronic device 110 as follows:

| Legal account | Legal password | Access authority |
|---|---|---|
| John | 1 3 5 7 9 | A |
| Emily | 24680 | B |
| James | 11223 | C |
| Mary | 33445 | D |

According to the first table, each legal account corresponds to one legal password and one access authority.

In addition, the user sets the security levels of the DFPs 123 and 124 via the specific application and sends the security levels of the DFPs 123 and 124 to the hub device 120. The hub device 120 generates a second table according to the security levels of the DFPs 123 and 124 as follows:

| Protected object | Security level |
|---|---|
| DFP 123 | A _{\grave{ }} B _{\grave{ }} C _{\grave{ }} D |
| DFP 124 | A |
| storage circuit 260 | D |

According to the first and second tables, each legal account recorded in the first table can access the peripheral device 130 connected to the DFP 123, but only the legal account John can access the peripheral device 140 connected to the DFP 124. The legal accounts Emily, James and Mary are not allowed to access the peripheral device 140 connected to the DFP 124.

After the hub device 120 stores the corresponding information, the information cannot be modified unless the user activates the specific application of the electronic device 110 again and modifies the legal accounts, the legal passwords, the access authorities and the security levels of the DFPs 123 and 124 stored in the hub device 120 via the specific application.

After writing the legal accounts, the legal passwords, and the access authorities to the hub device 120, the electronic device 110 may be removed and replaced with another electronic device (or referred to as a third electronic device). When the third electronic device wants to access the peripheral device 130 or 140, the hub device 120 requires the third electronic device to input a user account and a user password. The hub device 120 determines whether the user account and the user password provided by the third electronic device are legal. When the user account and the user password are legal, the hub device 120 then determines whether the access authority of the user account matches the security levels of the DFPs 123 and 124.

When the user account input by the third electronic device is John, since the user account matches the legal account in the first table and the access authority (A) of the legal account John in the first table matches the security level of the DFP 123, the hub device 120 allows the third electronic device to access the DFP 123. At this time, the hub device 120 may transmit the signal from the third electronic device to the DFP 123. However, when the user account input by the third electronic device is Emily, although the user account matches the legal account in the first table, the access authority (B) of the legal account Emily in the first table does not match the security level of the DFP 124. Therefore, hub device 120 blocks the third electronic device from accessing the DFP 124. At this time, the hub device 120 may not transmit the signal of the third electronic device to the DFP 124.

Since the hub device 120 can block illegal accounts, the data security of the peripheral devices 130 and 140 can be greatly increased, and the data of the peripheral devices 130 and 140 can be prevented from being stolen or tampered with. In addition, when the hub device 120 is coupled to the internet 170, since the control system 100 is an open system, other electronic devices (such as the electronic device 180) may be connected to the hub device 120 via the internet 170. Since the hub device 120 blocks illegal access operations, the security of network data can be greatly improved.

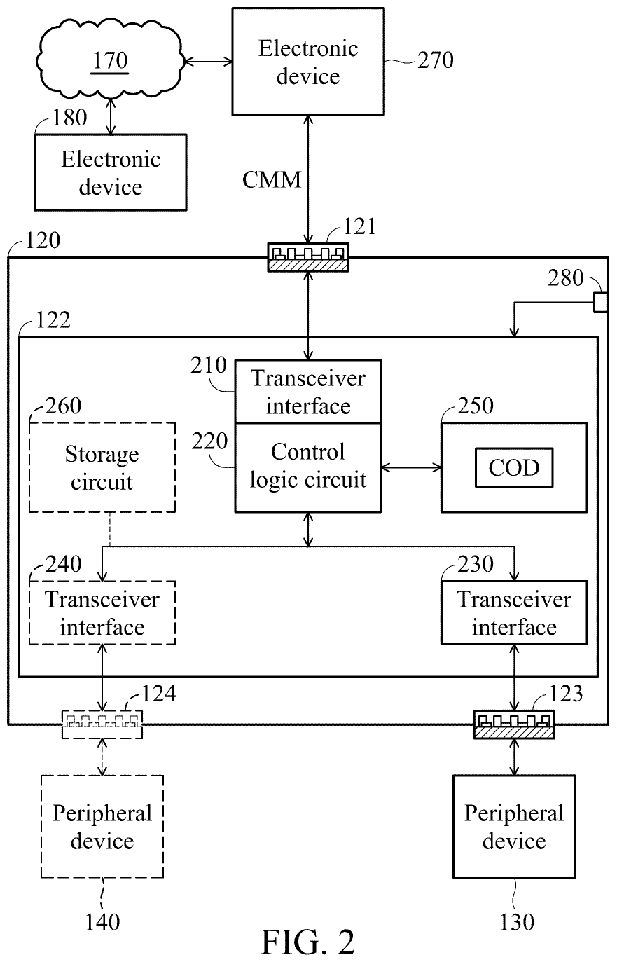

FIG. 2 is a schematic diagram of an exemplary embodiment of a control chip according to various aspects of the present disclosure. The control chip 122 comprises transceiver interfaces 210 and 230, and a control logic circuit 220. As shown in FIG. 2, the hub device 120 is coupled to an electronic device 270. The electronic device 270 is different from the electronic device 110. In this embodiment, the electronic device 110 is a legal device to set the security level of the DFP of the hub device 120 and provide the legal account, the legal password and the access authority. However, since the electronic device 110 may be removed and replaced with another electronic device, or the electronic device 110 may be connected to the internet 170 and indirectly connected to an illegal electronic device (such as the electronic device 180). For brevity, FIG. 2 shows another electronic device 270 coupled to the hub device 120. In this case, the legitimacy of electronic device 270 is unknown.

The transceiver interface 210 is coupled between the UFP 121 and the control logic circuit 220 for transmitting signals from the UFP 121 to the control logic circuit 220 and transmitting output signals from the control logic circuit 220 to the UFP 121. The data transmission method between the transceiver interface 210 and the UFP 121 may be a serial transmission method or a parallel transmission method.

The structure of the transceiver interface 210 is not limited in the present disclosure. In one embodiment, the transceiver interface 210 comprises a USB transceiver PHY. In this case, the transceiver interface 210 first converts the signal from the UFP 121 into a signal suitable for processing by the control logic circuit 220, and then provides the converted result to the control logic circuit 220. For example, the transceiver interface 210 converts the signal from the UFP 121 from a serial format (such as 2 bits) to a parallel format (such as 8 bits/16 bits/32 bits/64 bits), and then provides the signal in parallel format to the control logic circuit 220.

In other embodiments, the transceiver interface 210 converts the output signal of the control logic circuit 220 into a signal suitable for transmission by the upstream-facing port 121, and then provides the converted result to the UFP 121. For example, the transceiver interface 210 converts the signal from the control logic circuit 220 from a parallel format into a serial format, and then provides the signal in serial format to the UFP 121.

In some embodiments, when the UFP 121 is a LAN interface, the data transmission format between the transceiver interface 210 and the UFP 121 is a serial transmission format. Since the data transmission format between the transceiver interface 210 and the control logic circuit 220 is a parallel transmission format, the transceiver interface 210 converts the signal from the UFP 121 from a serial format to a parallel format, and then converts the signals in parallel format to control logic circuit 220. In this case, the transceiver interface 210 converts signals from the control logic circuit 220, for example, from a parallel format to a serial format, and then provides the signal in the serial format to the UFP 121. Since the UFP 121 is a LAN interface, the transceiver interface 210 does not comprise a USB transceiver PHY. Therefore, the circuit structure of the transceiver interface 210 is relatively simple, the component cost of the transceiver interface 210 is low, and it is not prone to heat generation. In one embodiment, the transceiver interface 210 may have a LAN port physical layer (PHY). The T transceiver interface 210 connects a media access control (MAC) sublayer to a physical medium, such as a network cable.

The transceiver interface 230 is coupled between the control logic circuit 220 and the DFP 123, and is used to transmit the output signal from the control logic circuit 220 to the DFP 123, and transmit the signal from the DFP 123 to the control logic circuit 220. In one embodiment, the data transmission format between the transceiver interface 230 and the control logic circuit 220 complies with a parallel transmission protocol, and the data transmission format between the transceiver interface 230 and the DFP 123 conforms to a serial transmission protocol.

The structure of the transceiver interface 230 is not limited in the present disclosure. In one embodiment, the transceiver interface 230 comprises a USB transceiver PHY. The transceiver interface 230 first converts the signal from the DFP 123 into a signal suitable for processing by the control logic circuit 220, and then provides the converted result to the control logic circuit 220. For example, the transceiver interface 230 converts the signal from the DFP 123 from a serial format to a parallel format, and then provides the signal in parallel format to the control logic circuit 220.

In other embodiments, the transceiver interface 230 converts the output signal of the control logic circuit 220 into a signal suitable for transmission by the DFP 123, and then provides the converted result to the DFP 123. For example, the transceiver interface 230 converts the signal from the control logic circuit 220 from a parallel format into a serial format, and then provides the signal in serial format to the DFP 123.

In other embodiment, the control chip 122 further comprises a transceiver interface 240. The transceiver interface 240 is coupled between the control logic circuit 220 and the DFP 124, and is used to transmit the output signal from the control logic circuit 220 to the DFP 124, and transmit the signal from the DFP 124 to the control logic circuit 220. Since the characteristic of the transceiver interface 240 is similar to the characteristic of the transceiver interface 230, the related description is omitted here.

The control logic circuit 220 is coupled between the transceiver interfaces 210, 230, and 240. When the UFP 121 receives the access command CMM of the electronic device 270, the control logic circuit 220 directs the electronic device 270 to provide a user account and a user password. The control logic circuit 220 determines whether the user account and the user password are legal. When the user account and the user password are legal, the control logic circuit 220 decodes the access command CMM to determine which DFP the access command CMM points to.

When the access command CMM points the DFP 123, the control logic circuit 220 determines whether the user account has the authority to access the DFP 123. When the user account does not have the authority which can access the DFP 123, the control logic circuit 220 ignores the access command CMM. In one embodiment, the control logic circuit 220 blocks the access command CMM from entering the DFP 123. When the user account has the authority to access the DFP 123, the control logic circuit 220 sends the access command CMM to the DFP 123. The structure of control logic circuit 220 is not limited in the present disclosure. In one embodiment, the control logic circuit 220 comprises a microcontroller unit (MCU) and a USB hub control circuit.

In some embodiments, the control chip 122 further comprises a storage circuit 250. The storage circuit 250 stores a program code COD. In this case, the control logic circuit 220 accesses the storage circuit 250 and executes the program code COD to determine whether the user account and the user password are legal, and whether the access authority of the user account matches the security levels of DFPs 123 and 124. In one embodiment, the control logic circuit 220 stores a plurality of legal user accounts and legal passwords and access authorities corresponding to the legal user accounts in the storage circuit 250. Additionally, the control logic circuit 220 also stores the security levels of the DFPs 123 and 124 in the storage circuit 250.

Taking the first and second tables as examples, assume that the user account is David and the user password is 13579. Since the user account David is not the same as the legal account recorded in the storage circuit 250, the control logic circuit 220 rejects the access command CMM of the electronic device 270. In another embodiment, assume that the user account is Emily and the user password is 12345. Since the user password does not match the legal password 24680 corresponding to the legal account Emily, the control logic circuit 220 rejects the access command CMM of the electronic device 270. In some embodiments, the control logic circuit 220 may require the electronic device 270 to re-provide a new user account and a new user password.

In other embodiments, assume that the user account provided by the electronic device 270 is Emily, and the user password provided by the electronic device 270 is 24680. Since the user account Emily matches a specific legal account of the legal accounts recorded in the first table and the user password (24680) matches the legal password corresponding to the specific legal account. The control logic circuit 220 determines which DFP the access command CMM points to.

When the access command CMM points to the DFP 123, since the access authority (B) of the legal account (Emily) in the first table matches the security level (A, B, C) of the DFP 123 in the second table, the user account Emily has the authority to access the DFP 123. The control logic circuit 220 provides the access command CMM to the DFP 123. At this time, the peripheral device 130 operates according to the access command CMM, such as outputting specific data to the electronic device 270.

However, when the access command CMM points to the DFP 124, since the access authority (B) of the legal account (Emily) in the first table does not match the security level (A) of the DFP 124 in the second table, the user account Emily does not have the authority to access the DFP 124. Therefore, the control logic circuit 220 does not provides the access command CMM to the DFP 124.

In other embodiments, the hub device 120 further includes a power receptacle (or referred to DC jack) 280. The power receptacle 280 is used to couple to a power adapter and receive the power provided by the power adapter. The power receptacle 280 provides power to each component of the control chip 122. Therefore, even when the upstream port 121 is coupled to the electronic device 270 via a network cable or a wireless device, the hub device 120 can still operate normally. In some embodiments, the peripheral device 130 or 140 may provide power to hub device 120. When the device connected to the hub device 120 (such as the electronic device 270 or the peripheral device 130 or 140) has a power supply function, the hub device 120 does not need to use the power provided by the power receptacle 280.

In one embodiment, the control chip 122 further comprises a storage circuit 260 for storing data. In this case, the storage circuit 250 records the security level of storage circuit 260. The security level of the storage circuit 260 may be set by the electronic device 110 in FIG. 1. When the access command CMM points to the storage circuit 260, the control logic circuit 220 determines whether the access authority of the user account provided by the electronic device 270 complies with the security level of the storage circuit 260.

For example, assume that the user account provided by the electronic device 270 is John, and the user password provided by the electronic device 270 is 13579. In this case, the user account and the user password provided by the electronic device 270 match the legal account and the legal password in the first table. At this time, if the access command CMM points to the storage circuit 260, the control logic circuit 220 determines whether the access authority (A) of the legal account John in the first table matches the security level (D) of the storage circuit 260 in the second table. Since the access authority (A) of the legal account John does not comply with the security level (D) of the storage circuit 260, the control logic circuit 220 refuses to send the access command CMM to the storage circuit 260. Therefore, the electronic device 270 cannot access the storage device 260.

However, if the user account provided by the electronic device 270 is Mary and the user password provided by the electronic device 270 is 33445, since the access authority (D) of the legal account Mary complies with the security level (D) of the storage circuit 260, the control logic circuit 220 sends the access command CMM to the storage circuit 260 to allow the electronic device 270 to access the storage circuit 260. In some embodiments, the storage circuit 260 is independent of the control chip 122 and is located with the control chip 126 in the hub device 120.

In other embodiments, when the user account does not have authority to access the DFP 123 or 124, or the storage circuit 260, the control logic circuit 220 may require the electronic device 270 to provide a new user account and a new user password. The control logic circuit 220 then determines whether the new user account and the new user password match the legal account and the legal password in the first table. In some embodiments, storage circuit 260 is independent of control chip 122. In this case, the control chip 122 further comprises a control circuit (not shown) coupled between the control logic circuit 220 and the storage circuit 260. The control logic circuit 220 accesses the storage circuit 260 via the control circuit.

In one embodiment, when the electronic device 270 sends the access command CMM, the control logic circuit 220 may generate an image signal to the electronic device 270, so that the screen of the electronic device 270 displays an OSD (on screen display) dialog box. The OSD dialog box provides two fields for users to enter a user account and a user password. The control logic circuit 220 then determines whether the access command CMM is legal according to the user account and the user password. Furthermore, when the user account or the user password is incorrect, or the access authority of the user account does not match the security level of the corresponding DFP (or storage circuit), the control logic circuit 220 re-provides the image signal, so that the electronic device 270 re-displays the OSD dialog box to allow the user to re-enter a new user account and a new user password.

In other embodiments, the access command CMM output by the electronic device 270 may come from the electronic device 180. In this case, the electronic device 180 provides the access command CMM to the hub device 120 via the internet 170 and the electronic device 270. In this case, the control logic circuit 220 requires the electronic device 180 to provide a user account and a user password via the electronic device 270 and the internet 170. For example, the control logic circuit 220 may provide an image signal to the electronic device 180 via the electronic device 270 and the internet 170, so that an OSD dialog box appears on the screen of the electronic device 180.

Since the hub device 120 can block illegal access commands, the data security of peripheral devices coupled to the DFP can be greatly improved. Furthermore, the hub device 120 can also prevent illegal electronic devices from accessing the internal data of the hub device 120, so data leakage can be avoided.

It will be understood that when an element is referred to as being “coupled to” another element, it can be directly coupled to the other element or intervening elements may be present. In contrast, when an element is referred to as be “directly connected to” or “directly coupled to” another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another. In the following claims, the terms “first,” “second,” etc. are used merely as labels, and are not intended to impose numerical requirements on their objects.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hub device comprising:
an upstream-facing port (UFP) receiving an access command provided by an electronic device;
a downstream-facing port (DFP) coupled to a peripheral device;
a control chip coupled between the UFP and the DFP and comprising:
a first transceiver interface coupled to the UFP;
a second transceiver interface coupled to the DFP;
a control logic circuit coupled between the first and second transceiver interfaces and directing the electronic device to provide a user account and a user password in response to the UFP receiving the access command,
wherein:
the control logic circuit determines whether the user account and the user password are legal,
in response to the user account and the user password being legal and the access command pointing the DFP, the control logic circuit determines whether the user account has the authority to access the DFP,
in response to the user account not having the authority to access the DFP, the control logic circuit ignores the access command,
in response to the user account having the authority to access the DFP, the control logic circuit transmits the access command to the DFP.

2. The hub device as claimed in claim 1, further comprising:
a first storage circuit storing a first table and a second table,
wherein:
the first table records a plurality of legal accounts, a plurality of legal passwords, and a plurality of access authorities,
each legal account corresponds to one legal password and one access authority,
the second table records a security level of the DFP,
the control logic circuit determines whether the user account is the same as one of the legal accounts,
in response to the user account being the same as a specific legal account of the legal accounts, the control logic circuit determines whether the user password matches the legal password corresponding to the specific legal account,
in response to the user password matching the legal password corresponding to the specific legal account, the control logic circuit determines whether the access command points the DFP.

3. The hub device as claimed in claim 2, wherein:
in response to the user account and the user password being legal, the control logic circuit determines whether an access authority corresponding to the specific legal account matches the security level of the DFP,
in response to the access authority corresponding to the specific legal account matching the security level of the DFP, the user account has the authority to access the DFP.

4. The hub device as claimed in claim 1, wherein the UFP comprises a wireless transceiver to receive the access command.

5. The hub device as claimed in claim 4, further comprising:
a power receptacle coupled to an adapter and receiving the power provided by the adapter.

6. The hub device as claimed in claim 1, wherein the UFP is a local area network (LAN) connection port.

7. The hub device as claimed in claim 1, further comprising:
a second storage circuit,
wherein:
the first storage circuit records the security level of the second storage circuit,
in response to the user account and the user password being legal and the access command pointing the second storage circuit, the control logic circuit determines whether the access authority corresponding to the specific legal account matches the security level of the second storage circuit,
in response to the access authority corresponding to the specific legal account matching the security level of the second storage circuit, the control logic circuit provides the access command to the second storage circuit.

8. The hub device as claimed in claim 28, wherein in response to the user account not having the authority to access the DFP, the control logic circuit directs the electronic device to modify the user account and the user password.

9. The hub device as claimed in claim 8, wherein in response to the user account not having the authority to access the DFP, the control logic circuit generates an image signal to the electronic device so that the electronic device displays a dialog box for the user to modify the user account and the user password.

10. A hub device, comprising:
an upstream-facing port (UFP) receiving an access command provided by an electronic device;
a downstream-facing port (DFP) coupled to a peripheral device;
a control chip coupled between the UFP and the DFP and comprising:
a first transceiver interface coupled to the UFP;
a second transceiver interface coupled to the DFP;
a first storage circuit storing a first table which records a plurality of legal accounts and a plurality of legal passwords, wherein each legal account corresponds to one legal password; and
a control logic circuit coupled between the first and second transceiver interfaces and directing the electronic device to provide a user account and a user password in response to the UFP receiving the access command,
wherein:
the control logic circuit determines whether the user account matches one of the legal accounts according to the first table,
in response to the user account matching a specific legal account of the legal accounts, the control logic circuit determines whether the user password matches a legal password corresponding to the specific legal account according to the first table,
in response to the user password matching the legal password corresponding to the specific legal account and the access command pointing to the DFP, the control logic circuit determines whether the user account has the authority to access the DFP,
in response to the user account not having the authority to access the DFP, the control logic circuit ignores the access command,
in response to the user account having the authority to access the DFP, the control logic circuit transmits the access command to the DFP.

11. The hub device as claimed in claim 64, wherein:
the first storage circuit further stores a second table which records the security level of the DFP,
in response to the user account being the same as the specific legal account, the user password matching the legal password corresponding to the specific legal account, and the access command pointing the DFP, the control logic circuit determines whether the specific legal account matches the security level of the DFP according to the second table,
in response to the specific legal account matching the security level of the DFP, the user account has the authority to access the DFP.

12. The hub device as claimed in claim 11, further comprising:
a second storage circuit disposed in the control chip,
wherein:
the second table records a security level of the second storage circuit,
in response to the user account being the same as the specific legal account, the user password matching a legal password corresponding to the specific legal account, and the access command pointing the second storage circuit, the control logic circuit determines whether the specific legal account matches the security level of the second storage circuit according to the second table, and
in response to the specific legal account matching the security level of the second storage circuit, the control logic circuit provides the access command to the second storage circuit.

13. The hub device as claimed in claim 88, wherein the UFP is a LAN connection port.

14. A hub device, comprising:
an upstream-facing port (UFP) receiving an access command provided by an electronic device;
a downstream-facing port (DFP) coupled to a peripheral device;
a control chip coupled between the UFP and the DFP and comprising:
a first transceiver interface coupled to the UFP;
a second transceiver interface coupled to the DFP;
a first storage circuit;
a control logic circuit coupled between the first and second transceiver interfaces and directing the electronic device to provide a user account and a user password in response to the UFP receiving the access command,
wherein:
the control logic circuit determines whether the user account and the user password are legal,
in response to the user account and the user password being legal and the access command pointing the first storage circuit, the control logic circuit determines whether the user account has the authority to access the first storage circuit,
in response to the user account not having the authority to access the first storage circuit, the control logic circuit ignores the access command,
in response to the user account having the authority to access the first storage circuit, the control logic circuit transmits the access command to the first storage circuit.

15. The hub device as claimed in claim 115, wherein:
in response to the user account and the user password being legal and the access command pointing the DFP, the control logic circuit determines whether the user account has the authority to access the DFP,
in response to the user account not having the authority to access the DFP, the control logic circuit ignores the access command,
in response to the user account having the authority to access the DFP, the control logic circuit transmits the access command to the DFP.

16. The hub device as claimed in claim 123, further comprising:
a second storage circuit storing a first table which records a plurality of legal accounts, a plurality of legal passwords, and a plurality of access authorities,
wherein:
each legal account corresponds to one legal password and one access authority,
the control logic circuit determines whether the user account is the same as one of the legal accounts according to the first table,
in response to the user account being the same as a specific legal account of the legal accounts, the control logic circuit determines whether the user password matches a legal password corresponding to the specific legal account according to the first table,
in response to the user password matching the legal password corresponding to the specific legal account, the control logic circuit determines whether the access command points the first storage circuit.

17. The hub device as claimed in claim 139, wherein:
the second storage circuit further stores a second table which records the security level of the DFP,
in response to the user account and the user password being legal, the control logic circuit determines whether the access authority corresponding to the specific legal account matches the security level of the DFP according to the second table,
in response to the access authority corresponding to the specific legal account matching the security level of the DFP, the control logic circuit provides the access command to the DFP.

18. The hub device as claimed in claim 149, wherein:
the second storage circuit further records the security level of the first storage circuit,
in response to the user account and the user password being legal and the access command pointing the first storage circuit, the control logic circuit determines whether the access authority corresponding to the specific legal account matches the security level of the first storage circuit according to the second table,
in response to the access authority corresponding to the specific legal account matching the security level of the first storage circuit, the control logic circuit provides the access command to the first storage circuit.

19. The hub device as claimed in claim 160, wherein in response to the user account not having the authority to access the DFP, the control logic circuit generates an image signal to the electronic device so that the electronic device displays a dialog box for the user to modify the user account and the user password.

20. The hub device as claimed in claim 19, wherein the UFP is a local area network (LAN) connection port.
